(19) United States
(12) Patent Application Publication
(10) Pub. No.: US 2023/0213609 A1
(43) Pub. Date: Jul. 6, 2023

(54) METHOD AND APPARATUS FOR INDOOR POSITIONING

(71) Applicant: VESTELLALAB INC., Seoul (KR)

(72) Inventors: Sangsu JUNG, Uiwang-si (KR); Eunjung LEE, Uiwang-si (KR); Young Soo LEE, Gunpo-si (KR); Dhananjay SINGH, Yongin-si (KR)

(73) Assignee: VESTELLALAB INC., Seoul (KR)

(21) Appl. No.: 18/008,893

(22) PCT Filed: Oct. 8, 2021
(86) PCT No.: PCT/KR2021/013894

§ 371 Date: Dec. 7, 2022

(30) Foreign Application Priority Data
Nov. 19, 2020 (KR) 10-2020-0155821

(51) Int. Cl. G01S 5/02

(52) U.S. Cl. CPC G01S 5/0242; G01S 5/02585; G01S 5/0269; G01S 2205/02

(57) ABSTRACT

A method for indoor positioning, depending upon an embodiment of the present invention, comprises the steps of: setting node data including information regarding the location of a positioning sensor on a movement path of a moving object with respect to an indoor space; obtaining first positioning data capable of determining a first section in which the moving object is currently located, by using at least one of the node data, first sensing data obtained through a sensor unit provided in the moving object, and second sensing data obtained through the positioning sensor; determining whether the first positioning data satisfies a preset reference value for a boundary node defining the first section; and determining subsequent positioning data of the first positioning data on the basis of at least one of the node data, information indicating whether the reference value is satisfied, and information indicating whether the boundary node rotates.

### TECHNICAL FIELD

The present invention relates to a method and an apparatus for indoor positioning.

### BACKGROUND ART

In general, a location may be determined using a GPS signal outdoors. In an outdoor environment, however, the influence of structures or obstacles which interfere with signal transmission and reception is small, and the error of signal transmission and reception is not large. However, when positioning indoors, there is a problem in that positioning accuracy is deteriorated due to a failure or an error of GPS signal reception caused by structures such as ceilings, walls, pillars, etc.

As a positioning method developed in response to the above problem, there are trilateration using a positioning sensor such as a beacon, Wi-Fi, etc., a fingerprint, a camera technique, and the like. However, the signal of the positioning sensor also has a limit in improving the accuracy of positioning due to an error caused by a surrounding environment.

### DISCLOSURE

### Technical Problem

Embodiments of the present invention are to provide a method and an apparatus for indoor positioning with improved accuracy.

### Technical Solution

A method for indoor positioning depending upon one embodiment of the present invention may include: setting node data including information regarding a location of a positioning sensor depending upon preset rules on a movement path of a moving object with respect to an indoor space; obtaining first positioning data capable of determining a first section in which the moving object is currently located, by using at least one of the node data, first sensing data obtained through a sensor unit provided in the moving object, and second sensing data obtained through the positioning sensor provided in the indoor space; determining whether the first positioning data satisfies a preset reference value for a boundary node defining the first section; and determining subsequent positioning data of the first positioning data on the basis of at least one of the node data, information indicating whether the reference value is satisfied, and information indicating whether the boundary node rotates.

If it is determined that the reference value is not satisfied in the determining of whether the reference value is satisfied, the determining of the subsequent positioning data may include calculating boundary coordinate values of boundary node data among the node data and a size of the second sensing data so as to obtain second positioning data regarding a location between the boundary nodes, in which the size of the second sensing data may correspond to a signal strength of the positioning sensor.

If it is determined that the reference value is satisfied in the determining of whether the reference value is satisfied, or if it is determined that the boundary node is a rotational node on the basis of the node data, the determining of the subsequent positioning data may include determining rotation information indicating whether a corresponding boundary node rotates and including a rotational direction on the basis of at least one of the node data and direction data calculated on the basis of the first sensing data; and calculating the subsequent positioning data for a subsequent section of the first section on the moving path of the moving object depending upon the determination result.

The determining of the rotation information may include: calculating first direction data regarding an amount of rotation of the moving object by using the first sensing data; and determining second direction data regarding the rotation direction by associating the first direction data with the node data, in which the first direction data may be calculated by performing a fusion operation on a first-1 coordinate value of first-1 sensing data and a first-2 coordinate value of first-2 sensing data.

If it is determined that the reference value is satisfied in the determining of whether the reference value is satisfied, and if it is determined that the boundary node is not a rotational node, the method may include: updating the first positioning data to data of any one boundary node data among the boundary nodes; and obtaining third-1 positioning data for a second section on an extension line in an existing traveling direction of the moving object, in which the second section may be a section adjacent to the first section.

If it is determined that the boundary node of the first section does not satisfy the reference value in the determining of whether the reference value is satisfied, if it is determined that the node satisfying the reference value is a different node other than the boundary node of the first section, and if it is determined that the different node is not a rotational node, the method may include: updating the first positioning data to data of the different node; and obtaining third-2 positioning data for a third section on an extension line in an existing traveling direction of the moving object, in which the different node may be a boundary node of the third section.

If it is determined that a boundary node rotates in the determining of the rotation information, the method may include: determining a proximity positioning sensor using the second sensing data; and obtaining fourth positioning data for a section in which a direction different from the existing traveling direction of the moving object may vary depending upon a location of the proximity positioning sensor.

If the proximity positioning sensor is located in the existing traveling direction, the fourth positioning sensor may include: fourth-1 positioning data obtained in a section changed depending upon the second direction data; fourth-2 positioning data obtained between a node of the proximity positioning sensor and a node adjacent thereto when the proximity positioning sensor is located in the changed section; and fourth-3 positioning data obtained in a section changed from a closest node in the existing traveling direction when the proximity positioning sensor is not located anywhere in the existing traveling direction and the changed section.

An apparatus for indoor positioning depending upon one embodiment of the present invention may include: a control unit and a sensor unit, in which the control unit is configured to set node data including information regarding a location of a positioning sensor depending upon preset rules on a movement path of a moving object with respect to an indoor space; obtain first positioning data capable of determining a first section in which the moving object is currently located, by using at least one of the node data, first sensing data obtained through a sensor unit, and second sensing data obtained through the positioning sensor provided in the indoor space; determine whether the first positioning data satisfies a preset reference value for a boundary node defining the first section; and determine subsequent positioning data of the first positioning data on a basis of at least one of the node data, information indicating whether the reference value is satisfied, and information indicating whether the boundary node rotates.

If it is determined that the reference value is not satisfied when determining whether the reference value is satisfied, the control unit may be configured to calculate boundary coordinate values of boundary node data among the node data and a size of the second sensing data so as to obtain second positioning data regarding a location between the boundary nodes, in which the size of the second sensing data may correspond to a signal strength of the positioning sensor.

If it is determined that the reference value is satisfied when determining whether the reference value is satisfied, or if it is determined that the boundary node is a rotational node on the basis of the node data, the control unit may be configured to determine rotation information indicating whether a corresponding boundary node rotates and including a rotational direction on the basis of at least one of the node data and direction data calculated on the basis of the first sensing data, and calculate the subsequent positioning data for a subsequent section of the first section on the moving path of the moving object depending upon the determination result.

The control unit may calculate first direction data regarding an amount of rotation of the moving object by using the first sensing data, and determine second direction data regarding the rotation direction by associating the first direction data with the node data, so as to determine the rotation information, in which the first direction data may be calculated by performing a fusion operation on a first-1 coordinate value of first-1 sensing data and a first-2 coordinate value of first-2 sensing data.

If it is determined that the reference value is satisfied when determining whether the reference value is satisfied, and if it is determined that the boundary node is not a rotational node, the control unit may be configured to update the first positioning data to data of any one boundary node data among the boundary nodes, and obtain third-1 positioning data for a second section on an extension line in an existing traveling direction of the moving object, in which the second section may be a section adjacent to the first section.

If it is determined that the boundary node of the first section does not satisfy the reference value when determining whether the reference value is satisfied, if it is determined that the node satisfying the reference value is a different node other than the boundary node of the first section, and if it is determined that the different node is not a rotational node, the control unit may be configured to update the first positioning data to data of the different node, and obtain third-2 positioning data for a third section on an extension line in an existing traveling direction of the moving object, in which the different node may be a boundary node of the third section.

If it is determined that a boundary node rotates when determining the rotation information, the control unit may be configured to determine a proximity positioning sensor using the second sensing data, and obtain fourth positioning data for a section in which a direction different from the existing traveling direction of the moving object may vary depending upon a location of the proximity positioning sensor.

If the proximity positioning sensor is located in the existing traveling direction, the fourth positioning sensor may include: fourth-1 positioning data obtained in a section changed depending upon the second direction data; fourth-2 positioning data obtained between a node of the proximity positioning sensor and a node adjacent thereto when the proximity positioning sensor is located in the changed section; and fourth-3 positioning data obtained in a section changed from a closest node in the existing traveling direction when the proximity positioning sensor is not located anywhere in the existing traveling direction and the changed section.

### Advantageous Effects

Depending upon embodiments of the present invention, a method and an apparatus for indoor positioning with improved accuracy may be provided by using a positioning algorithm which utilizes node data within a movable path.

### DESCRIPTION OF DRAWINGS

FIG. 1 is a view schematically showing a configuration of an indoor positioning system depending upon one embodiment of the present invention.

FIG. 2 is a view more specifically showing a configuration of an indoor positioning system depending upon one embodiment of the present invention.

FIG. 3 is a view showing a configuration of a sensor unit depending upon one embodiment of the present invention.

FIG. 4 is a view for explaining node data depending upon one embodiment of the present invention.

FIG. 5 is a view for explaining a single path positioning method depending upon one embodiment of the present invention.

FIG. 6 is a view for explaining a single path positioning method depending upon another embodiment of the present invention.

FIG. 7 is a view for explaining a single path positioning method depending upon another embodiment of the present invention.

FIG. 8 is a view for explaining a multiple path positioning method depending upon one embodiment of the present invention.

FIG. 9 is a flowchart for explaining an indoor positioning method depending upon one embodiment of the present invention.

FIG. 10 is a flowchart for more specifically explaining a part of an indoor positioning method depending upon one embodiment of the present invention.

FIG. 11 is a flowchart for explaining determining the rotation information of a moving object depending upon one embodiment of the present invention.

FIG. 12 is a flowchart for more specifically explaining a part of a multiple path positioning method depending upon one embodiment of the present invention.

### MODE FOR INVENTION

The present invention may be applied with various modifications and have various embodiments, but specific embodiments will be illustrated in the drawings and described in detail in the detailed description. Effects and features of the present invention and methods of achieving the same will become apparent with reference to the embodiments described below in detail along with the accompanying drawings. However, the present invention may be implemented in various forms without limitation to the embodiments disclosed below.

Hereinafter, the embodiments of the present invention will be described in detail with reference to the accompanying drawings, and when described with reference to the drawings, the same or corresponding components are given the same reference numerals, and the overlapping description thereof will be omitted.

In the following embodiments, terms such as first, second, etc. are used for the purpose of distinguishing one component from another without limiting meaning. In the following embodiments, the terms of a singular form may include plural forms unless otherwise specified. In the following embodiments, terms such as “include,” “have,” or the like mean that the features or components described in the specification are present, and the possibility that one or more other features or components may be added is not excluded in advance. In the drawings, the size of the components may be exaggerated or reduced for convenience of description. For example, since the size and shape of each component shown in the drawings are arbitrarily indicated for convenience of description, the present invention is not necessarily limited to what is shown.

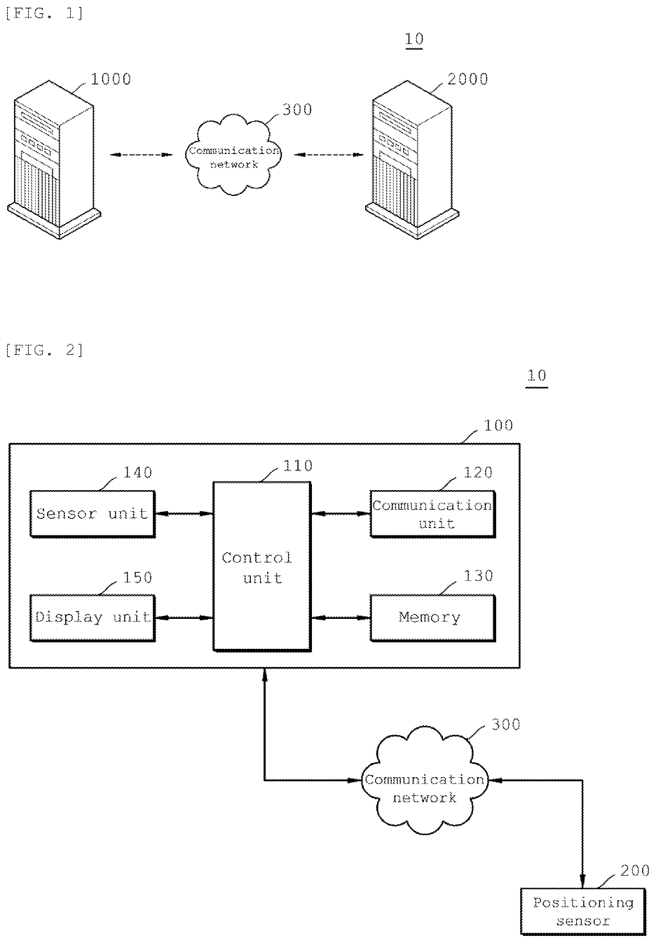

FIG. 1 is a view schematically showing a configuration of an indoor positioning system 10 depending upon one embodiment of the present invention.

The indoor positioning system 10 depending upon one embodiment of the present invention may include an indoor positioning server 1000 and an indoor space server 2000. The two servers 1000 and 2000 may communicate through a communication network 300 and exchange data with each other.

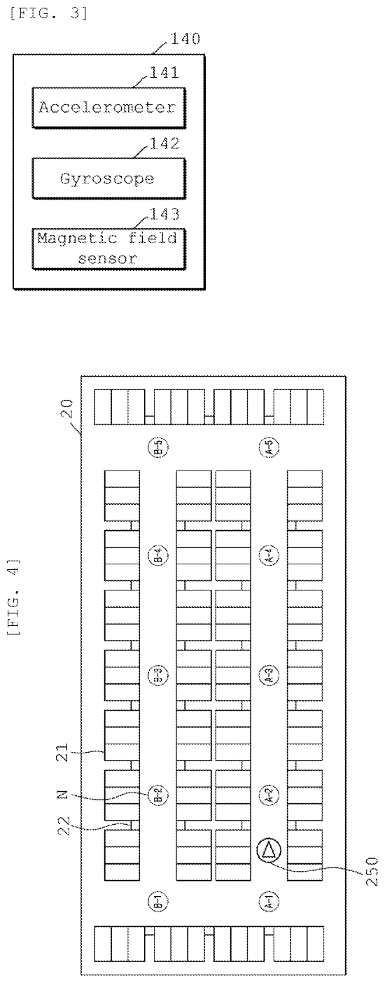

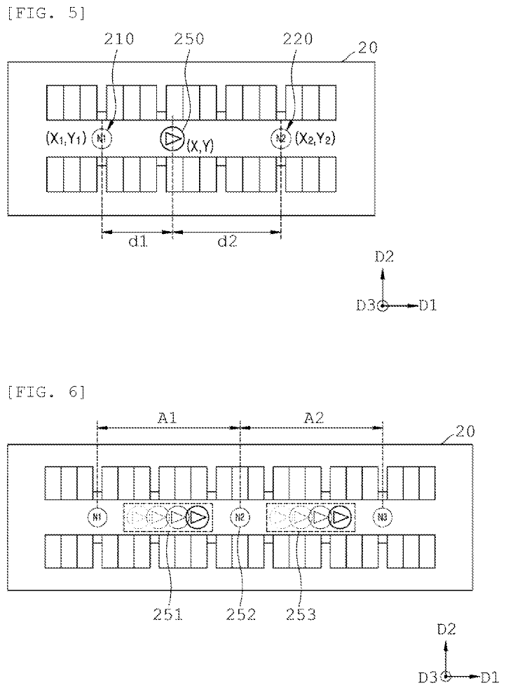

The indoor positioning server 1000 may perform indoor positioning of a moving object which moves in an indoor space. For this purpose, the indoor positioning server 1000 may include the indoor positioning device 100 as shown in FIGS. 2 and 3, which will be described in more detail with reference to FIGS. 2 and 3 to be described later. The indoor positioning server 1000 may be a server which manages a positioning application installed in the indoor positioning device 100. The indoor positioning server 1000 and the indoor positioning device 100 may exchange data with each other through the application.

The indoor space server 2000 may be a server related to the indoor space in which the moving object to be positioned in the present disclosure moves. The indoor space of the present disclosure may be various spaces having obstacles in receiving GPS signals, such as indoor/underground parking lots, tunnels, underground roads, underground shopping malls, inside of buildings, and the like. The indoor space server 2000 may be a local server present in each individual indoor space, or may be a central server which manages information about several indoor spaces. Hereinafter, the indoor space may be described, for example, as an indoor parking lot and the indoor space server 2000 may be described as a parking lot server. The indoor space server 2000 may include a positioning sensor 200 as shown in FIG. 2 for indoor positioning of the moving object.

Depending upon embodiments, an operating body of the indoor positioning server 1000 and the indoor space server 2000 may be the same.

The communication network 300 may mean a communication network which mediates data transmission and reception between respective components of the positioning system 10. For example, the communication network 300 may encompass wired networks such as local area networks (LANs), wide area networks (WANs), metropolitan area networks (MANs), integrated service digital networks (ISDNs), etc., or wireless networks such as Wi-Fi, wireless LANs, CDMA, Bluetooth, satellite communications, etc., but the scope of the present invention is not limited thereto.

Hereinafter, a configuration of the indoor positioning system 10 depending upon one embodiment of the present invention will be described in more detail with reference to both FIGS. 2 and 3. FIG. 2 is a view more specifically showing a configuration of an indoor positioning system depending upon one embodiment of the present invention, and FIG. 3 is a view showing a configuration of a sensor unit depending upon one embodiment of the present invention.

The indoor positioning device 100 may be a device corresponding to a moving object such as a vehicle, etc., and may be a mobile terminal such as a mobile phone, a tablet PC, or the like, which is owned by an owner of the vehicle, or may be an electronic device connected to or built into the vehicle. An application for performing an indoor positioning method for a moving object depending upon one embodiment of the present invention may be installed in the indoor positioning device 100. Hereinafter, the location concept of the moving object may be described in combination with the location concept of the indoor positioning device 100.

The indoor positioning device 100 may include a control unit 110, a communication unit 120, a memory 130, a sensor unit 140, and a display unit 150. In addition, although not shown in this drawing, an input/output interface, etc., other than the display unit 150 may be further included.

The control unit 110 may perform an operation of overall controlling the indoor positioning device 100. A specific operation of the control unit 110 will be described in more detail in related drawings to be described later.

The control unit 110 may include all types of devices capable of processing data, such as a processor. Herein, a “processor” may refer to a data processing device built in hardware having a physically structured circuit to perform functions expressed by codes or instructions included in a program, for example. As one example of the data processing unit built in the hardware, there may be processing devices such as a microprocessor, a central processing unit (CPU), processor core, multiprocessor, application-specific integrated circuit (ASIC), field programmable gate array (FPGA), etc., but the scope of the present invention is limited thereto.

The communication unit 120 may be a device including hardware and software necessary for transmitting and receiving control signals, data or the like through the communication network 300 depending upon various types of communication methods. The communication unit 120 may communicate with various types of external devices and servers, such as the positioning sensor 200 or the indoor space server 2000 of FIG. 2.

The memory 130 may temporarily and/or permanently store all types of data generated and processed by the indoor positioning device 100. The memory 130 may store program applications, data, commands, etc. installed in the indoor positioning device 100 and store all types of data input and output through the indoor positioning device 100. The memory 130 may include a random access memory (RAM), a read only memory (ROM) and a permanent mass storage device such as a disk drive, a flash storage medium, a solid state drive (SSD), and the like, but the scope of the present invention is not limited thereto.

Herein, the sensor unit 140 will be described with reference to FIG. 3. The sensor unit 140 may be a sensor for obtaining movement information including the position of a moving object, whether or not the object has moved, a movement direction/angle, and a posture, and may include a plurality of sensors for sensing the state of the inside or outside of the device 100. The sensor unit 140 may include at least one of an accelerometer 141, a gyroscope 142, and a magnetic field sensor 143. First sensing data about the movement information of the moving object may be obtained through the sensor unit 140.

The accelerometer 141 may sense the acceleration of the moving object and may be a three-axis sensor of X-axis, Y-axis, and Z-axis. The gyroscope 142 may sense the angular velocity of the moving object and may be a three-axis sensor of Rx, Ry, and Rz. The accelerometer 141 may measure the movement inertia of the moving object by using the acceleration of the moving object (g (1 g=9.8 m/s2) as one example of the unit), and the gyroscope 142 may measure a rotational inertia and/or a rotation rate (deg/sec as one example of the unit) by using the angular velocity of the moving object. For example, the control unit 110 may obtain the movement information of the moving object by using sensing values of the accelerometer 141 and the gyroscope 142. With regard to the movement information, the control unit 110 may obtain rotation information (amount of angle change) and speed information including information on the roll angle, pitch angle and yaw angle of the moving object.

The magnetic field sensor 143 may measure the azimuth of the moving object. The range of variation of the sensing values obtained by the magnetic field sensor 143 may decrease when the moving object is stationary without moving. When the change value of an outputted sensor value is equal to or less than a preset reference, it may be determined that the vehicle is in a stopped state. The control unit 110 may reduce an error when determining whether the moving object moves or rotates by using the sensing value of the magnetic field sensor 143 together with the sensing value of the accelerometer 141 and the gyroscope 142. As such, the indoor positioning device 100 may determine the motion and speed information of the moving object in various directions in three dimensions including the three axes based on the first sensing data obtained through the sensor unit 140.

Referring back to FIG. 2, the display unit 150 may display data input and output through the indoor positioning device 100. Positioning data processed and output by the indoor positioning method depending upon one embodiment of the present invention may be displayed through the display unit 150 in an output method depending upon the operation of a positioning application stored in the indoor positioning device 100. FIGS. 4 to 8 to be described later are examples of display screens output through the display unit 150.

Depending upon embodiments, the indoor positioning device 100 may be provided separately from the indoor positioning server 1000 outside the indoor positioning server 1000.

The indoor space server 2000 may include the positioning sensor 200 installed in an indoor space for indoor positioning of the moving object. As one example, the positioning sensor 200 may be a beacon module which transmits a beacon signal including a beacon ID through the communication network 300. The beacon signal may include a universally unique identifier (UUID), a major ID, a minor ID, and a received signal strength indication (RSSI). As one example, the major ID and the minor ID may consist of three digit numbers, and a unique number for each floor may be assigned to the hundreds' digit, and a unique number for each beacon may be assigned to the tens' digit and the ones' digit. RSSI may correspond to the strength of the beacon signal. In this case, the positioning sensor 200 may periodically wirelessly transmit the beacon signal to the indoor positioning server 1000 through all available wireless communication networks 300 such as Wi-Fi, Bluetooth, Zigbee, long term evolution (LTE), 3G, etc.

Hereinafter, data obtained by the positioning sensor 200 may refer to second sensing data, and the second sensing data may mean the beacon signal.

FIG. 4 is a view for explaining node data depending upon one embodiment of the present invention, and is an example of a display screen displayed through the display unit 150.

On the display screen, an indoor space 20, a parking surface 21, an obstacle 22, etc. may be shown in the form of data-processed images, and the parking surface 21 and the obstacle 22 may be appropriately disposed in the actual indoor space 20. Hereinafter, the indoor space 20 will be described as an example of a parking lot 20.

The control unit 110 may set node data including information about the location of the positioning sensor 200 depending upon a rule set in advance on a movement path through which the moving object may move with respect to the indoor space 20.

In the indoor space 20, a remaining space excluding the parking surface 21 and the obstacle 22 may be a movement path through which the moving object may move. A plurality of nodes N indicating the locations of the positioning sensor 200 (see FIG. 2) installed depending upon preset rules are shown on the movement path. Hereinafter, the “location of node N” and the “location of the positioning sensor 200” may be used interchangeably for description. The positioning sensors 200 may be installed at regular intervals depending upon preset rules on the movement path. The nodes may also be set on the parking surface 21 depending upon an embodiment.

As one example, in FIG. 4, the plurality of nodes N may include node A on a first movement path and node B on a second movement path, while nodes A may include A-1, A-2, A-3, A-4, and A-5 nodes, and node B may include nodes B-1, B-2, B-3, B-4, and B-5. However, the location and number of the plurality of nodes N are not limited thereto.

Node data depending upon one embodiment of the present invention relates to location information where the positioning sensor 200 may be installed, and the location information may include an ID of the positioning sensor 200, self-location information of each of a plurality of nodes N, and connection information between nodes different from each other.

The plurality of nodes N may include a first node where a positioning operation starts, a final node where the positioning operation ends, a rotational node located at an intersection such as a three-way intersection, crossroads, or the like, an intermediate node located between the nodes, and the like. As one example, the first node may correspond to an entrance of the indoor space, and the final node may correspond to an exit of the indoor space. In FIG. 4, node A-1 may be the first node, node B-1 may be the final node, nodes A-5 and B-5 may be rotational nodes, and other nodes may be intermediate nodes. As such, the positioning sensor 200 may be installed on a straight path of the moving object, a point where the direction of the moving object is changed, such as an intersection, and the like. At this time, if a distance between two adjacent positioning sensors 200 on the straight path is larger than a predetermined reference, an additional positioning sensor 200 may be installed therebetween to increase the accuracy of positioning.

The control unit 110 may use at least one of the node data, first sensing data obtained through the sensor unit 140, and second sensing data obtained through the positioning sensor 200 provided in the indoor space 20, so as to obtain first positioning data capable of determining a first section in which the object is currently located. For example, the first positioning data may include current location coordinates as the current position of the moving object (at the starting point of a positioning operation), distance information between the indoor positioning device 100 and the positioning sensor 200, and the like.

After that, the controller 110 may determine whether the first positioning data satisfies a preset reference value for a boundary node defining the first section. For example, if the first section in FIG. 4 is a section between nodes A-2 and A-3, two nodes A-2 and A-3 may be boundary nodes of the first section. For example, whether the reference value is satisfied may be determined is determined when a calculated distance between the positioning sensor 200 and the indoor positioning device 100 is less than or equal to a certain value, that is, depending upon whether the moving object has come close to the specific positioning sensor 200 within a certain distance. If it is determined that the reference value is satisfied, the following positioning operation (next positioning sensor 200) may be performed. Depending upon an embodiment, conditions for satisfying the reference value may refer to how continuously and how frequently the indoor positioning device 100 receives sensor signals from various positioning sensors 200, and may be changed within various ranges for convenience of positioning. Depending upon an embodiment, conditions for satisfying the reference values may refer to whether the indoor positioning device 100 and various positioning sensors 200 are relatively close by using the RSSI data, which may be used together with the above-mentioned frequency.

After that, subsequent positioning data of first positioning data may be determined on basis of at least one of information indicating whether the reference value is satisfied, and information indicating whether the boundary node rotates. A specific example of determining subsequent positioning data based on information indicating whether the reference value is satisfied, information indicating whether the boundary note rotates, and the like will be described in the drawings to be described later.

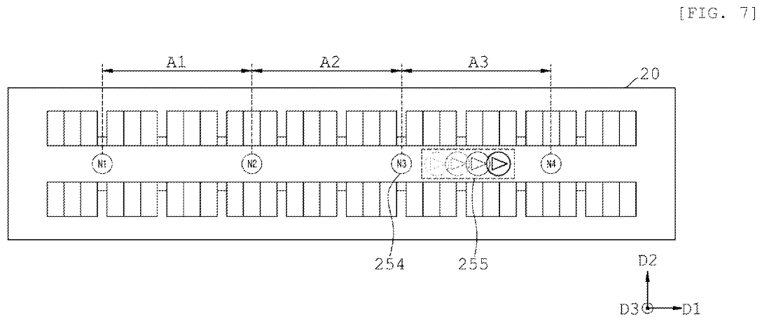

FIG. 5 is a view for explaining a single path positioning method depending upon one embodiment of the present invention, and relates to an embodiment in which it is determined that the reference value is not satisfied when the control unit 110 determines whether the reference value is satisfied. The “single path” (straight path) may mean a movement path between two nodes N1 and N2.

The control unit 110 may calculate the size of the second sensing data and the boundary coordinate values of the boundary node data among the node data so as to obtain the second positioning data regarding a location between the boundary nodes. The size of the second sensing data may correspond to the signal strength of the positioning sensor 200, and may be, for example, RSSI of a beacon signal.

Specifically, the second positioning data may be obtained by calculating a point of internal division between the boundary coordinate value of the boundary node data and the size of the second sensing data.

Referring to FIG. 5, a first node N1 and a second node N2 on a moving path and the moving object moving between the two nodes N1 and N2 (“first section”) are shown. In this case, the moving object is shown as an UI object 250 displayed on the display screen, and the UI object 250 may be described as being identical to the moving object 250. The first node N1 may be a location where the first positioning sensor 210 is installed, and the second node N2 may be a location where the second positioning sensor 220 is installed. The first positioning data described in FIG. 5 may represent the current location coordinates (not shown) of the moving object 250, the boundary node data may represent the location coordinates (X₁, Y₁) and (X₂, Y₂) of the two nodes N1 and N2, and the second positioning data may represent the subsequent location coordinates (X, Y) of the moving object 250 to be described later.

The control unit 110 may calculate the location of the moving object 250 on the straight path based on the RSSI included in the beacon signals transmitted from the two positioning sensors 210 and 220. Specifically, the control unit 110 may measure first distance information between the positioning sensors 210 and 220 and the moving object 250 based on RSSI, and calculate second distance information between the two nodes N1 and N2 of the moving object 250 by using the first distance information and the height information from a reference plane of the indoor space in a third direction D3. In other words, the second distance information may refer to a distance of D1-D2 when viewed in a plan view, and may mean a distance between a projected point on the floor of the indoor space 20 of the positioning sensor 200 and the moving object 250. Hereinafter, the node N may be described as meaning a projected point on the floor of the positioning sensor 200. The second distance information may refer to a distance between the moving object 250 and any one of the plurality of nodes N. In FIG. 5, the second distance information may include a first distance d1 between the moving object 250 and the first node N1 and a second distance d2 between the moving object 250 and the second node N2.

Specifically, the positioning of the moving object 250 between the two nodes N1 and N2 on the straight path, that is, the second positioning data may be calculated by the following equations.

$$X = {X}_{2} + ( {X}_{1} - {X}_{2} ) \times \frac{d 2}{d 1 + d 2} \qquad [ Equation 1 ]$$

$$Y = {Y}_{2} + ( {Y}_{1} - {Y}_{2} ) \times \frac{d 2}{d 1 + d 2} \qquad [ Equation 2 ]$$

Depending upon the above equations, the second positioning data (subsequent location coordinates of the moving object 250) may be calculated through a point of internal division based on the second distance information d1 and d2 calculated based on the location coordinates of the node and the signal strength of the positioning sensor 200.

As such, when the current location information (first positioning data) of the moving object does not satisfy a signal reference value for the boundary node N1 or N2 in the first section, the control unit 110 may determine the moving object as moving between the two nodes N1 and N2 and calculate a specific location of the moving object 250 in the first section by calculating subsequent location information (second positioning data).

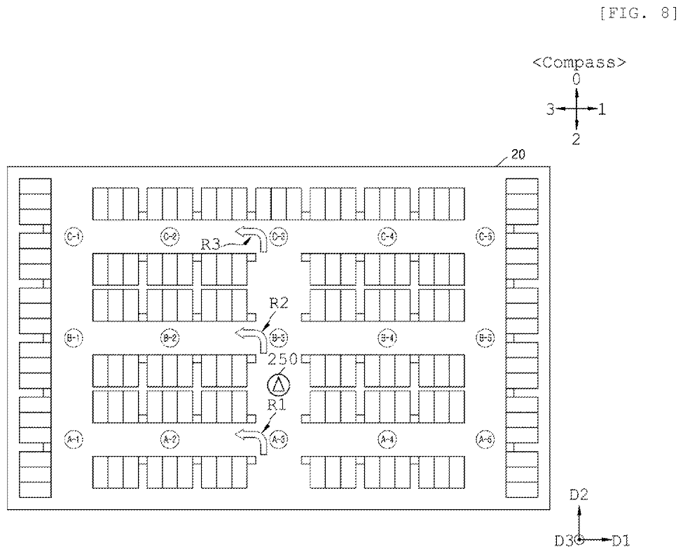

FIG. 6 is a view for explaining a single path positioning method depending upon another embodiment of the present invention, and relates to an embodiment in which it is determined that the reference value is satisfied when the control unit 110 determines whether the reference value is satisfied. In other words, it is determined that the moving object approaches the boundary node N2 on one side of the first section A1. The “single path” (straight path) may mean a movement path on an extension line connecting the three nodes N1, N2, and N3.

The control unit 110 may determine a type of a corresponding boundary node or rotation information indicating whether a corresponding boundary node rotates and including a rotational direction on the basis of at least one of the node data and direction data calculated on the basis of the first sensing data by the sensing unit 140. The determining of the type of boundary node by using the node data may determine whether the corresponding boundary node is a node on a single path (straight path) or a rotational node on a multiple path, for example, by using a beacon signal assigned to each node. Meanwhile, a detailed method of determining the rotation information will be described in detail in FIG. 8 to be described later. After that, the control unit 110 may calculate subsequent positioning data for a subsequent section A2 following a first section A1 on the moving path of the moving object depending upon the determination result.

For example, referring to FIG. 6, if the control unit 110 determines that the boundary node is a node on a single path or determines that the boundary node is not a rotational node based on the node data, the control unit 110 may update the above-described first positioning data 251 as boundary node data of any one of the boundary nodes, or location data 252 of the second node N2 in this drawing. Depending upon an embodiment, if it is determined that the moving object does not rotate when determining the rotation information, an operation of FIG. 6 may be performed, for example, when the direction data is calculated to be the same as the existing direction. After that, the control unit 110 may obtain third-1 positioning data 253 for the second section A2 on an extension line with an existing traveling direction of the moving object. In this drawing, the first positioning data 251 may include a location of the moving object which changes in real time in the first section A1 and the third-1 positioning data 253 may include a location of the moving object which changes in real time in the second section A2 all.

In an embodiment of this drawing, it is shown that the first section A1 and the subsequent section A2 may be adjacent to each other. Hereinafter, an embodiment in which the subsequent section is not adjacent to the first section A1 will be described.

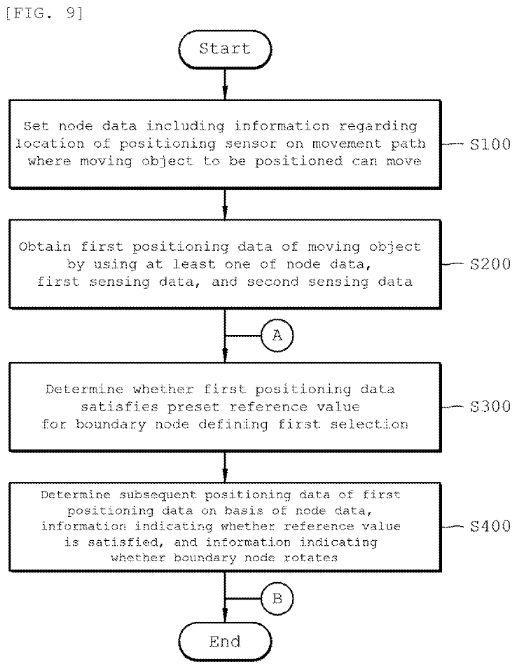

FIG. 7 is a view for explaining a single path positioning method depending upon another embodiment of the present invention, and the parts which are different from those of FIG. 6 will be mainly described.

While the moving object is moving in the first section A1 as described above, if it is determined that the node satisfying the reference value is not the second node N2, which is a boundary node in the direction of traveling, but the third node N3 next thereto, the control unit 110 may perform the operation as described in FIG. 6 in a third section A3 which is not adjacent to the first section A1. Specifically, in the determining whether the reference value is satisfied by the control unit 110, if it is determined that the boundary node of the first section A1 does not satisfy the reference value, if it is determined that the node satisfying the reference value is a different node other than the boundary node of the first section A1, and if it is determined that the different node is not a rotational node, the operation of this drawing may be performed. In this case, the other node may mean a boundary node of the third section A3.

For example, the control unit 110 may update the first positioning data to the location data 254 of the other node, which is the third node N3 in this drawing, and then the third-2 positioning data 255 for the third section A3 may be obtained.

In the above, the case where the node satisfying the reference value is located on the straight path of the moving object has been described as an example, but the node may be located on a path in a direction different from that of the straight path.

FIG. 8 is a view for explaining a multiple path positioning method depending upon one embodiment of the present invention, and may refer to a display screen in which the indoor space 20 includes a plurality of rotation sections R1, R2, and R3. In an upper right corner of FIG. 8, a compass variable is shown as second direction data to be described later.

The control unit 110 may calculate first direction data about the amount of rotation of the moving object by using the first sensing data.

The “first direction data” may be calculated by performing a fusion operation on the first-1 coordinate values of the first-1 sensing data and the first-2 coordinate values of the first-2 sensing data. The first-1 and first-2 sensing data may follow the concept included in the first sensing data obtained by the sensor unit 140. The first-1 sensing data may be a sensing value obtained by the accelerometer 141, and the first-2 sensing data may be a sensing value obtained by the gyroscope 142. In other words, the rotation amount and rotation direction of the moving object may be calculated by using the sensing values of the accelerometer 141 and the gyroscope 142, which will be described in detail later.

The two sensors 141 and 142 may be three-axis sensors, and the first-1 coordinate value and the first-2 coordinate value are (acc(x), acc(y), acc(z)), (gyr(x), gyr(y), gyr(z)), respectively. The “first direction data” may include the following first change amount, second change amount, and third change amount. Assuming that a radian change per second is a first change amount (^{Δ}s1), a degree change per second is a second change amount (^{Δ}s2), and an actual degree change is a third change amount (^{Δ}s3), each value may be as shown in the following equations.

$$Δ s 1 = \frac{acc ( x ) \times gyr ( x ) + acc ( y ) \times gyr ( y ) + acc ( z ) \times gyr ( z )}{\sqrt{{acc ( x )}^{2} + {acc ( y )}^{2} + {acc ( z )}^{2}}} \qquad [ Equation 3 ]$$

$$Δ s 2 = \frac{Δ s 1 \times 180}{π} \qquad [ Equation 4 ]$$

$$Δ s 3 = \frac{Δ s 2 \times ( time difference )}{1000} \qquad [ Equation 5 ]$$

In equation 5, 1000 may be a variable determined based on the value of time, meaning that the unit of 1000 is seconds (sec). In other words, referring to equation 5, the third change amount (Δs3), which is an actual change amount, may be obtained by integrating the second change amount (Δs2). For example, since the second change amount (Δs2) is not limited by the amount of rotation and the third change amount (Δs3) is an actual change amount at a point in time, a degree value at which the third change amount (Δs3) is accumulated may have a value within the range of degree 0 to 360 degrees. For example, if the moving object rotates and the degree value at which the third change amount (Δs3) is accumulated becomes a value larger than 360 degrees, a calculation may be made by changing to 0 degree again. If the degree value at which the third change amount (Δs3) is accumulated becomes a value less than 0 degree, a calculation is made by changing to 360 degrees again.

After that, the control unit 110 may determine the rotation information by associating the aforementioned first direction data and node data to determine second direction data regarding the rotation direction. In this case, as an example of the second direction data, description will be made with reference to the compass variable shown in the upper right corner of FIG. 8.

In this drawing, the compass variable may be set as an example of having four values of East, West, South, North (values of 1, 2, and 3 in a clockwise direction from 0) considering the node data on the possible movement path of the moving object. For example, with an assumption of 0<a<90 (degrees), if the degree value at which the third change amount (Δs3) is accumulated is greater than or equal to (360−a) degrees and less than or equal to +a degrees, the control unit 110 may determine the second direction data as 0. If the degree value at which the third change amount (Δs3) is accumulated is greater than or equal to (90−a) degrees and less than or equal to (90+a) degrees, the control unit may determine the second direction data as 1. If the degree value at which the third change amount (Δs3) is accumulated is more than or equal to (180−a) degrees and less than or equal to (180+a) degrees, the control unit may determine the second direction data as 2. And, if the degree value at which the third change amount (Δs3) is accumulated is more than or equal to (270−a) degrees and less than or equal to (270+a) degrees, the control unit may determine the second direction data as 3.

In determining the rotation information, the type of the first direction data and the second direction data and the determination method thereof are not limited to those described above.

After that, if it is determined that a boundary node rotates when determining the rotation information, the control unit 110 may determine a proximity positioning sensor by using the second sensing data.

For example, in this drawing, if the second direction data (compass variable) is changed from 0 to 3, the control unit 110 may determine that the moving object rotates in any one of the plurality of rotation sections R1, R2, and R3. Then, the proximity positioning sensor of the moving object 250 may be determined by using the second sensing data of the positioning sensor 200 corresponding to each node among neighboring nodes of the moving object 250.

After that, the control unit 110 may obtain fourth positioning data for a changed path in a direction different from that of the existing traveling direction D2 of the moving object depending upon the location of the proximity positioning sensor. The fourth positioning data may include fourth-1, fourth-2, and fourth-3 positioning data to be described later depending upon the number of cases.

First, if the proximity positioning sensor is located in the existing traveling direction D2, that is, if the node corresponding to the proximity positioning sensor is any one of A-3, B-3 and C-3 in this drawing, the control unit 110 may obtain the fourth-1 positioning data in a section which changes depending upon the second direction data (compass variable: 3).

For example, in this drawing, if it is determined that the node of the proximity positioning sensor is node B-3, a movement path may be changed in the second rotation section R2 formed at node B-3 depending upon the second direction data (compass variable is changed from 0 to 3) in B-3. After that, a single-path section positioning may be performed in a section between node B-3 and node B-2, which is a changed path.

In other words, the first positioning data, which is an initial location of the moving object, is replaced with rotation node data depending upon whether the reference value is satisfied and rotation information, and subsequent positioning data of the changed section on the changed path may be calculated.

Then, if the proximity positioning sensor is located in the changed section, the control unit 110 may obtain the fourth-2 positioning data between the node of the proximity positioning sensor and a node adjacent thereto. In this drawing, if the proximity positioning sensor is any one of A-2, B-2, and C-2 on the movement path in the first direction D1, the control unit 110 may change the path depending upon the second direction data changed at the rotational nodes A-3, B-3, and C-3 adjacent to the node of the proximity positioning sensor on one side. After that, the fourth-2 positioning data may be calculated in a section between the node of the proximity positioning sensor and the nodes A-1, B-1, and C-1 adjacent thereto on the other side.

For example, in this drawing, if it is determined that the proximity positioning sensor is the C-2 node, the movement path may be changed in the third rotation section R3 formed at the C-3 node, and then the above-described single-path section positioning may be performed between the C-2 node and the C-1 node.

Then, in an exceptional case where the proximity positioning sensor is not located in either the existing traveling direction D2 or the section (first direction D1) on the changed path, the control unit 110 may change a movement path depending upon the second direction data changed at the node which is the closest to the existing traveling direction D2. After that, the fourth-3 positioning data may be obtained in a section on the changed path.

For example, in this drawing, if it is determined that the proximity positioning sensor is a node A-4, B-4, C-4, A-5, B-5, C-5, or another sensor not shown in the drawing due to an operation error of the indoor positioning device 100, the positioning sensor 200 or the like, the path may be changed depending upon the second direction data changed at the nearest rotational node on the current path of the moving object, which is a node B-3 in this drawing, and the fourth-3 positioning data may be calculated in a changed section (between B-3 and B-2 and between B-2 and B-1) on the path in one direction D1.

The aforementioned third positioning data and fourth positioning data may be calculated by using the same principle as that of the second positioning data. The third positioning data may mean positioning data in a subsequent section on a single path. For example, the aforementioned third-1 positioning data 253 (see FIG. 6) and third-2 positioning data 255 (see FIG. 7) may be included.

If it is determined that the moving object does not rotate in the rotation section, the control unit 110 may perform the aforementioned single-path positioning in the corresponding section.

As such, depending upon the indoor positioning method depending upon one embodiment of the present invention, the indoor positioning with improved quickness and accuracy may be possible through positioning algorithms in various cases using a movement path in which a moving object is movable in an indoor space and preset node data in the movement path.

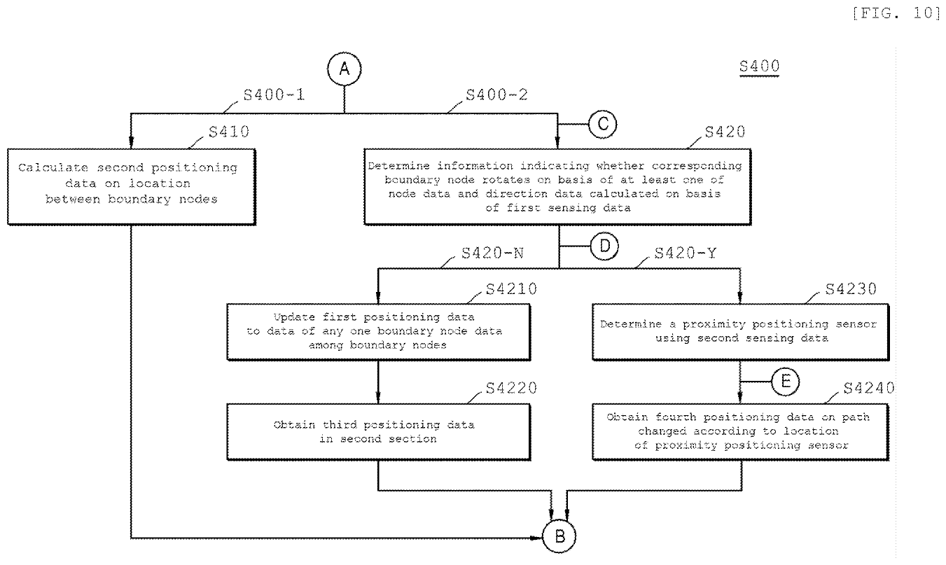

FIG. 9 is a flowchart for explaining an indoor positioning method depending upon one embodiment of the present invention. The indoor positioning method may include steps to be described later, and will be described with reference to the above-described drawings.

Node data including information about the location of the positioning sensor 200 may be set depending upon a rule set in advance on a movement path through which the moving object may move with respect to the indoor space 20 (S100).

After that, at least one of the node data, first sensing data obtained through the sensor unit 140 provided in the moving object, and second sensing data obtained through the positioning sensor 200 provided in the indoor space 20, may be used to obtain first positioning data capable of determining a first section in which the object is currently located.

Whether first positioning data satisfies preset reference value for boundary node defining first selection may be determined (S300).

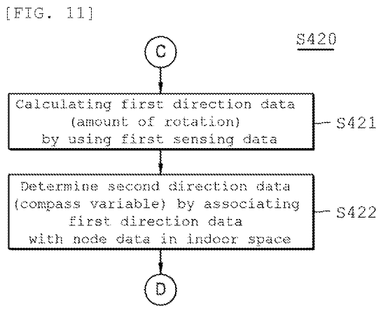

After that, subsequent positioning data of first positioning data may be determined on the basis of at least one of the node data, information indicating whether the reference value is satisfied, and information indicating whether the boundary node rotates (S400). S400 will be described in more detail in FIGS. 10 to 12 to be described later.

In this drawing, S400 is shown to be performed after S300, but S300 and S400 may be performed in parallel.

In this case, the first sensing data may include information on the location, direction, angle, posture, etc., of the moving object per se, and the second sensing data may include signal strength (RSSI) as a beacon signal.

FIG. 10 is a flowchart for more specifically explaining the determining of subsequent positioning data (S400) as a part of an indoor positioning method depending upon one embodiment of the present invention. S400 may include the steps to be described below.

If it is determined that the reference value is not satisfied (S400-1) in the determining of whether the reference value is satisfied, the determining of the subsequent positioning data may include calculating boundary coordinate values of boundary node data among the node data and a size of the second sensing data so as to obtain second positioning data regarding a location between the boundary nodes (S410).

In this case, the size of the second sensing data may correspond to the signal strength of the positioning sensor 200. The second positioning data may be obtained by calculating a point of internal division between the boundary coordinate value of the boundary node data and the size of the second sensing data.

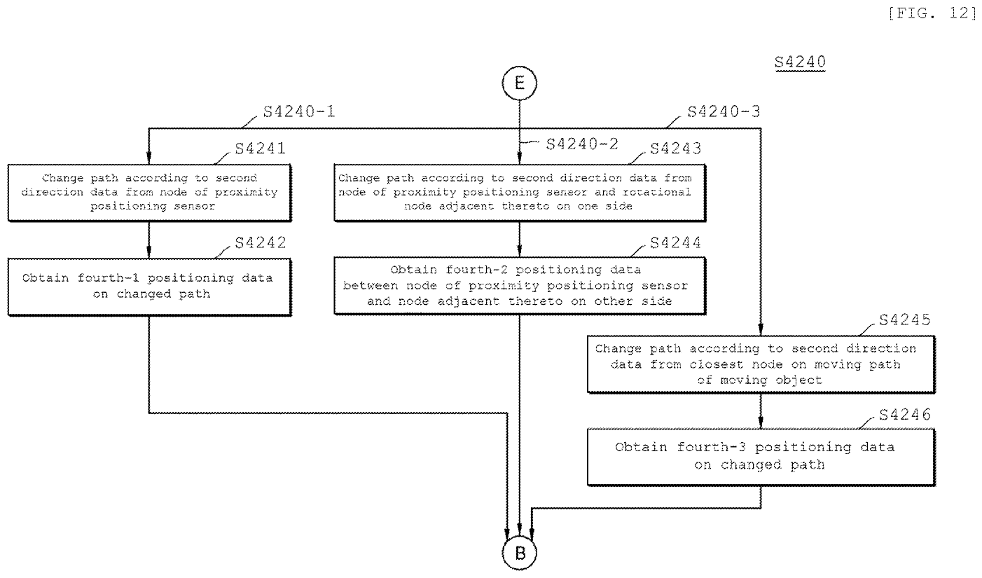

If it is determined that the reference value is satisfied in the determining of whether the reference value is satisfied, or if it is determined that the boundary node is a rotational node on the basis of the node data regardless of whether the reference value is satisfied (S400-2), it may be possible to determine rotation information indicating whether a corresponding boundary node rotates and including a rotational direction on the basis of at least one of the node data and direction data calculated on the basis of the first sensing data (S420). S420 will be described in more detail in FIG. 11 to be described later.

After that, it may be possible to calculate subsequent positioning data for a subsequent section following the first section on the moving path of the moving object depending upon the determination result (S4210, S4220, S4230, S4240). Specifically, the above may be as follows.

In the determining of rotation information (s420), if it is determined that the reference value is satisfied in the determining of whether the reference value is satisfied, and if it is determined that the boundary node is not a rotational node (S420-N), the first positioning data may be updated to any one boundary node data among the boundary nodes (S4210), and obtain the third-1 positioning data for a second section on an extension line in an existing traveling direction of the moving object (S4220).

Unlike the above, in the determining of rotation information (S420), if it is determined that the boundary node is a rotational node regardless of whether the reference value is satisfied (S420-Y), it may be possible to determine a proximity positioning sensor by using the second sensing data (S4230), and obtain the fourth positioning data for a changed path in a direction different from that of the existing traveling direction D2 of the moving object depending upon the location of the proximity positioning sensor (S4240). The number of cases of the fourth positioning data will be described in more detail in FIG. 12 to be described later.

The aforementioned third positioning data and fourth positioning data may be calculated by using the same principle as that of the second positioning data.

FIG. 11 is a flowchart for explaining determining the rotation information of a moving object depending upon one embodiment of the present invention. The determining of rotation information (S420) may include the steps to be described later.

The first direction data about the amount of rotation of the moving object may be calculated by using the first sensing data (S421). The first direction data may be calculated by performing a fusion operation on a first-1 coordinate value of first-1 sensing data which is obtained by the accelerometer 141 and a first-2 coordinate value of first-2 sensing data which is obtained by the gyroscope 142, and may specifically include first, second and third change amounts calculated through equations 3 to 5 described above.

After that, the second direction data regarding a rotation direction may be determined by associating the first direction data with the node data set on a digital map background of the indoor space (S422). As one example, the second direction data may be a compass variable as shown in FIG. 8.

FIG. 12 is a flowchart for more specifically explaining a part of a multiple path positioning method depending upon one embodiment of the present invention. In the obtaining of the fourth positioning data (S4240), the fourth positioning data may include the number of cases to be described later.

If the proximity positioning sensor is located in the existing traveling direction (S4240-1), it may be possible to change the movement path depending upon the second direction data changed at the node of the proximity positioning sensor (S4241) and obtain the fourth-1 positioning data in a changed section on the changed path (S4242).

If the proximity positioning sensor is located in the changed section (S4240-2), it may be possible to change the movement path depending upon the second direction data changed at the rotational node adjacent to the node of the proximity positioning sensor on one side (S4243) and obtain the fourth-2 positioning data between the node of the proximity positioning sensor, and the node adjacent thereto on the other side (S4244).

Meanwhile, if the proximity positioning sensor is not located anywhere in the existing traveling direction and the changed section (S4240-3), it may be possible to change the movement path depending upon the second direction data at a closest node in the existing traveling direction of the moving object (S4245) and obtain the fourth-3 positioning data in a changed section on the changed path (S4246).

Embodiments depending upon the present invention as described above may be implemented in the form of a computer program which may be executed on a computer through various components, and such a computer program may be recorded on a computer-readable medium. In this case, the medium may store a program executable by a computer. Examples of the medium may include magnetic media such as hard disks, floppy disks and magnetic tapes, optical recording media such as CD-ROM and DVD, magneto-optical media such as floptical disks, and ROM, RAM, flash memory, etc., and thus may be configured to store program instructions.

Meanwhile, the computer program may be specially designed and configured for the present invention, or may be known and usable to those skilled in the art of computer software. An example of a computer program may include not only machine language codes generated by a compiler but also high-level language codes which may be executed by a computer using an interpreter or the like.

In addition, although preferred embodiments of the present invention have been shown and described above, the present invention is not limited to the specific embodiments described above. Of course, various modifications can be made by those skilled in the art to which the present invention pertains without departing from the gist of the present invention claimed in the claims, and these modifications should not be individually understood from the technical spirit or perspective of the present invention.

Therefore, the spirit of the present invention should not be limited to the above-described embodiments, and all scopes equivalent to or equivalently changed from the claims as well as the claims described below would be considered to fall within the scope of the spirit of the present invention.

1. A method for indoor positioning, the method comprising:
setting node data including information regarding a location of a positioning sensor depending upon preset rules on a movement path where a moving object is movable with respect to an indoor space;
obtaining first positioning data capable of determining a first section in which the moving object is currently located, by using at least one of the node data, first sensing data obtained through a sensor unit provided in the moving object, and second sensing data obtained through the positioning sensor provided in the indoor space;
determining whether the first positioning data satisfies a preset reference value for a boundary node defining the first section; and
determining subsequent positioning data of the first positioning data on a basis of at least one of the node data, information indicating whether the reference value is satisfied, and information indicating whether the boundary node rotates.

2. The method of claim 1, wherein when it is determined that the reference value is not satisfied in the determining of whether the reference value is satisfied, the determining of the subsequent positioning data includes calculating boundary coordinate values of boundary node data among the node data and a size of the second sensing data so as to obtain second positioning data regarding a location between the boundary nodes, in which the size of the second sensing data corresponds to a signal strength of the positioning sensor.

3. The method of claim 1, wherein when it is determined that the reference value is satisfied in the determining of whether the reference value is satisfied, or when it is determined that the boundary node is a rotational node on the basis of the node data, the determining of the subsequent positioning data includes determining rotation information indicating whether a corresponding boundary node rotates and including a rotational direction on the basis of at least one of the node data and direction data calculated on the basis of the first sensing data; and calculating the subsequent positioning data for a subsequent section of the first section on the moving path of the moving object depending upon the determination result.

4. The method of claim 3, wherein the determining of the rotation information indicating whether a corresponding boundary node rotates includes: calculating first direction data regarding an amount of rotation of the moving object by using the first sensing data; and determining second direction data regarding the rotation direction by associating the first direction data with the node data, in which the first direction data is calculated by performing a fusion operation on a first-1 coordinate value of first-1 sensing data and a first-2 coordinate value of first-2 sensing data.

5. The method of claim 3, wherein when it is determined that the reference value is satisfied in the determining of whether the reference value is satisfied, and when it is determined that the boundary node is not a rotational node, the method includes: updating the first positioning data to data of any one boundary node data among the boundary nodes; and obtaining third-1 positioning data for a second section on an extension line in an existing traveling direction of the moving object, in which the second section is a section adjacent to the first section.

6. The method of claim 3, wherein when it is determined that the boundary node of the first section does not satisfy the reference value in the determining of whether the reference value is satisfied, when it is determined that the node satisfying the reference value is a different node other than the boundary node of the first section, and when it is determined that the different node is not a rotational node, the method includes: updating the first positioning data to data of the different node; and obtaining third-2 positioning data for a third section on an extension line in an existing traveling direction of the moving object, in which the different node is a boundary node of the third section.

4. The method of claim 4, wherein when it is determined that a boundary node rotates in the determining of the rotation information indicating whether a corresponding boundary node rotates, the method includes: determining a proximity positioning sensor using the second sensing data; and obtaining fourth positioning data for a section in which a direction different from the existing traveling direction of the moving object varies depending upon a location of the proximity positioning sensor.

8. The method of claim 7, wherein when the proximity positioning sensor is located in the existing traveling direction, the fourth positioning sensor includes: fourth-1 positioning data obtained in a section changed depending upon the second direction data; fourth-2 positioning data obtained between a node of the proximity positioning sensor and a node adjacent thereto when the proximity positioning sensor is located in the changed section; and fourth-3 positioning data obtained in a section changed from a closest node in the existing traveling direction when the proximity positioning sensor is not located anywhere in the existing traveling direction and the changed section.

9. An apparatus for indoor positioning, the apparatus comprising: a control unit and a sensor unit, wherein the control unit is configured to set node data including information regarding a location of a positioning sensor depending upon preset rules on a movement path of a moving object with respect to an indoor space; obtain first positioning data capable of determining a first section in which the moving object is currently located, by using at least one of the node data, first sensing data obtained through a sensor unit, and second sensing data obtained through the positioning sensor provided in the indoor space; determine whether the first positioning data satisfies a preset reference value for a boundary node defining the first section; and determine subsequent positioning data of the first positioning data on a basis of at least one of the node data, information indicating whether the reference value is satisfied, and information indicating whether the boundary node rotates.

10. The apparatus of claim 9, wherein when it is determined that the reference value is not satisfied when determining whether the reference value is satisfied, the control unit is configured to calculate boundary coordinate values of boundary node data among the node data and a size of the second sensing data so as to obtain second positioning data regarding a location between the boundary nodes, in which the size of the second sensing data corresponds to a signal strength of the positioning sensor.

11. The apparatus of claim 9, wherein when it is determined that the reference value is satisfied when determining whether the reference value is satisfied, or when it is determined that the boundary node is a rotational node on the basis of the node data, the control unit is configured to determine rotation information indicating whether a corresponding boundary node rotates and including a rotational direction on the basis of at least one of the node data and direction data calculated on the basis of the first sensing data, and calculates the subsequent positioning data for a subsequent section of the first section on the moving path of the moving object depending upon the determination result.

12. The apparatus of claim 11, wherein the control unit calculates first direction data regarding an amount of rotation of the moving object by using the first sensing data, and determines second direction data regarding the rotation direction by associating the first direction data with the node data, so as to determine the rotation information indicating rotation, in which the first direction data is calculated by performing a fusion operation on a first-1 coordinate value of first-1 sensing data and a first-2 coordinate value of first-2 sensing data.

13. The apparatus of claim 11, wherein when it is determined that the reference value is satisfied when determining whether the reference value is satisfied, and when it is determined that the boundary node is not a rotational node, the control unit is configured to update the first positioning data to data of any one boundary node data among the boundary nodes, and obtain third-1 positioning data for a second section on an extension line in an existing traveling direction of the moving object, in which the second section is a section adjacent to the first section.

14. The apparatus of claim 3, wherein when it is determined that the boundary node of the first section does not satisfy the reference value when determining whether the reference value is satisfied, when it is determined that the node satisfying the reference value is a different node other than the boundary node of the first section, and when it is determined that the different node is not a rotational node, the control unit is configured to update the first positioning data to data of the different node, and obtain third-2 positioning data for a third section on an extension line in an existing traveling direction of the moving object, in which the different node is a boundary node of the third section.

15. The apparatus of claim 12, wherein when it is determined that a boundary node rotates when determining the rotation information, the control unit is configured to determine a proximity positioning sensor using the second sensing data, and obtain fourth positioning data for a section in which a direction different from the existing traveling direction of the moving object varies depending upon a location of the proximity positioning sensor.

16. The apparatus of claim 15, wherein when the proximity positioning sensor is located in the existing traveling direction, the fourth positioning sensor includes: fourth-1 positioning data obtained in a section changed depending upon the second direction data; fourth-2 positioning data obtained between a node of the proximity positioning sensor and a node adjacent thereto when the proximity positioning sensor is located in the changed section; and fourth-3 positioning data obtained in a section changed from a closest node in the existing traveling direction when the proximity positioning sensor is not located anywhere in the existing traveling direction and the changed section.
